(19) United States
(12) Patent Application Publication
(10) Pub. No.: US 2024/0009821 A1
(43) Pub. Date: Jan. 11, 2024

(54) Nail Gun Reload Indicator

(71) Applicants: James Morris Boyer, Saint Simons Island, GA (US); Brandee Beth Boyer, Saint Simons Island, GA (US)

(72) Inventors: James Morris Boyer, Saint Simons Island, GA (US); Brandee Beth Boyer, Saint Simons Island, GA (US)

(21) Appl. No.: 18/445,358

(22) Filed: Jul. 31, 2023

(51) Int. Cl. B25C 5/16

(52) U.S. Cl. CPC B25C 5/1689

(57) ABSTRACT

The nail gun indicator gives the user an alarm when the nail supply is or near depletion. The indicator beeps and a light comes on to make the user aware of the need to replenish the nail supply thus creating a more effective product with their nail gun of choice.

This invention provides an improvement as well as an important safety feature to an existing product, a standard nail gun. The ‘Nail Gun Reload Indicator” can be attached externally or can be incorporated into the design by the manufacturer.

The Nail Gun Reload Indicator is a feature that will alert the user as to the status of the nail supply in the gun. This will prevent the user from getting into a precarious situation with an inadequate supply of nails. An example would be, A carpenter on a ladder holding a heavy beam and trying to nail it in place and the nail gun is empty.

Let it be noted that for the purpose of this application, the term “nail gun” will apply to all pneumatic or gas driven fasteners.

### CROSS REFERENCE TO RELATED PATENT APPLICATIONS

This patent application is a continuation-in-part of U.S. patent application No. 60/837,836 filed on Aug. 6, 2006, and entitled “Nail Gun Reload Indicator”, which is incorporated in its entirety herein by this reference.

### FIELD OF INVENTION

According to the major aspects and broadly stated, the present invention generally related to the field of power tools, and particularly to a gauge for determining the need to reload a nail gun device. In the event that a nail gun reaches near the end of a round of nails, the nail gun reload indicator device sounds and alarm and emits a light to warn the user that the nail gun will soon be depleted of nails.

### BACKGROUND OF THE INVENTION

The nail gun reload indicator saves time and money, while increasing efficiency and safety in the work place. Efficiency and safety are the most important aspects of this invention. The nail gun reload indicator will revolutionize the way a user is able to adapt their nail gun to work situations. The safety aspects and time saving will immediately be realized by the nail gun user.

Time and effort are saved in the work place when the “nail gun reload indicator” is used on a nail gun. An example of saving time and money is evident when the user of the nail gun is aware of the nail quantity in the nail gun before attempting to secure a heavy load. The nail guns used today do not allow the user to know if the nail supply is depleted. When the nail gun user is made aware of the absence of nails before a task, much time and frustration can be saved.

The “nail gun reload indicator” can decrease dangerous conditions in the workplace. Adding this feature to a nail gun allows the nail gun user to know if the nail gun is firing without dispensing nails. The user may assume a wall or roof component is properly nailed, when in fact there were no nails dispensing from the nail magazine. Improperly supported heavy objects over head create a danger in the workplace, that is eliminated with the “nail gun reload indicator”.

The “nail gun reload indicator” can eliminate the dangerous conditions involved in roofing and the installation of decking. Roof pitches often exceed a 45 degree angle, thus taking a great deal of strength and dexterity to move from ground to roof. To place the first run of plywood on the rafters is usually a three man operation. Two men place the plywood in position with a great deal of difficulty, while the third man quickly nails the plywood in place. It is important to be quick this action, in order to keep the plywood from sliding off the roof. If the nail gun is empty, it increases the time the plywood must be held in place to reload the nail gun. This, increasing worker fatigue.

### SUMMARY OF NAIL GUN RELOAD INDICATOR

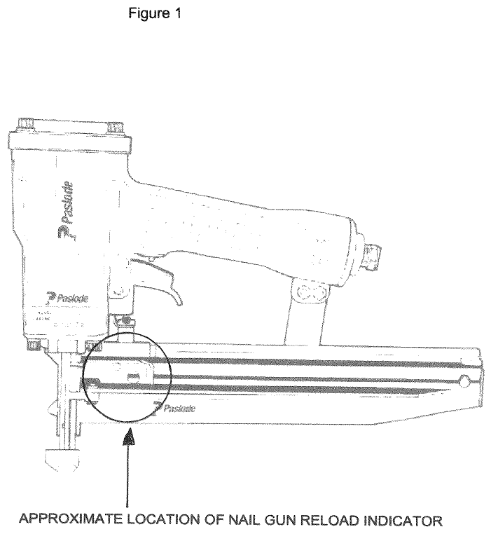

For the purpose of this summary, the nail gun reload indicator is shown on a framing gun. For the interpretation of the “nail gun reload indicator”, refer to FIG. 1.

The following describes, briefly, the action involved in making the “nail gun reload indicator” successful in of itself. There are many nail fasteners and staplers on the market today. While each brand differs in design, the basic principle for holding and advancing a fastener into the firing sleeve, via a constant force spring, remain the same.

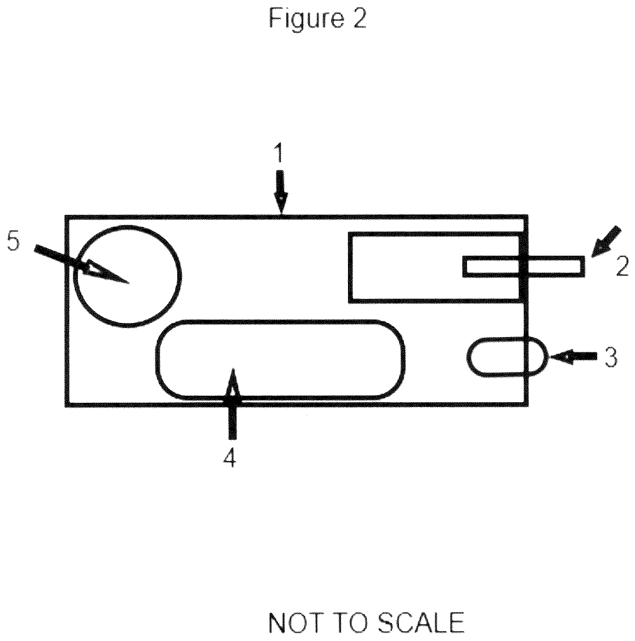

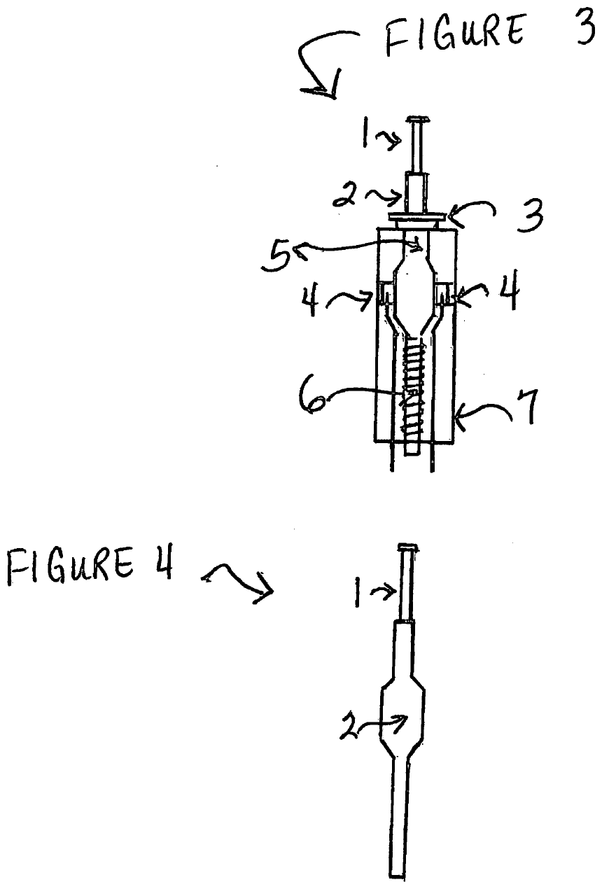

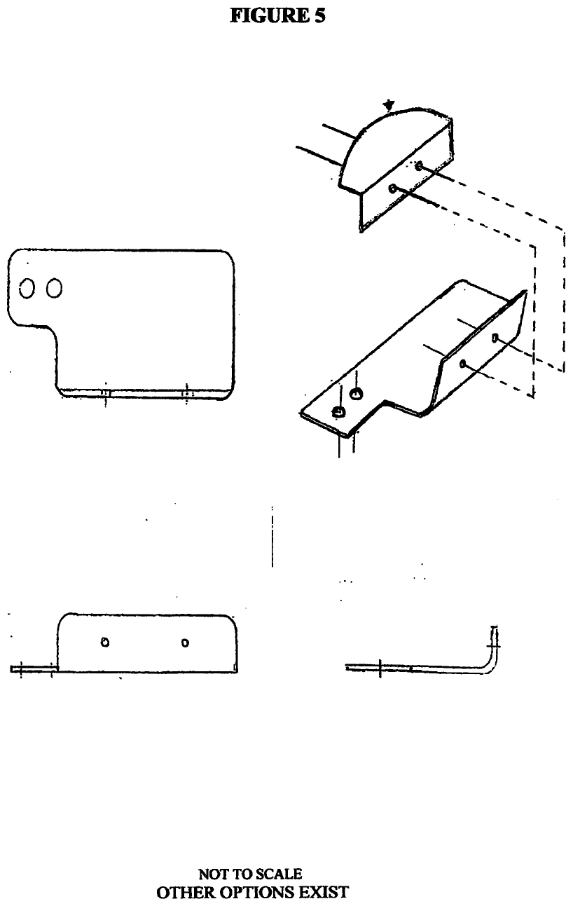

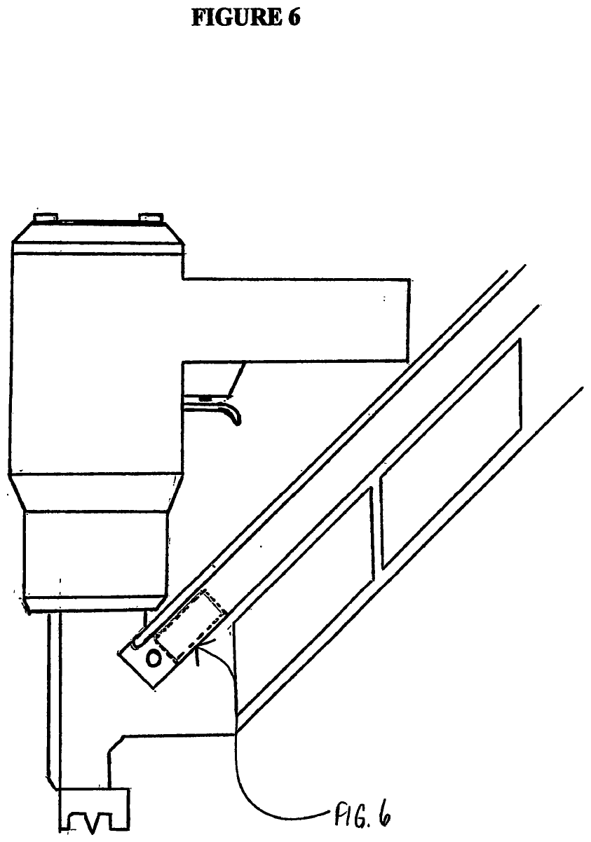

The principle parts of the nail gun reload indicator can be seen in FIG. 2. The device consists of an impact resistant casing (1), an actuator switch (2), an audible buzzer or continuous tone alarm (5) and a battery (4). The casing should be small and weather resistant. The casing should be small enough and placed so as to not interfere with the operation of the nail gun. The audio/visual aspect of the “Nail Gun Reload Indicator” is the invention. These components can be incorporated into the manufacturing process of design.

It is believed that the present invention and many of its attendant advantages will be understood by forgoing descriptions. It is also believed that it will be apparent that various changes may be made in form, construction and arrangement of the components thereof without departing from the scope and spirit of the invention or without sacrificing all of its material advantages. The form herein before described being merely an explanatory embodiment thereof.

We claim:

1. The “nail gun reload indicator” will eliminate the dangers and inconveniences related to the inability of the user of a nail gun to recognize when the nails and the nail gun need to be reloaded. The achievement of the end result of the nail gun reload indicator are not limited to those mentioned, and this patent application the end result will be to alert the user of a nail gun as to when there is a need to replenish the supply of nails and the nail gun.

2. The. “nail gun reload indicator”, as described in claim one, can be adapted to all brands of nail guns, framing, or trim, pneumatic, electric or power.

3. The “nail gun reload indicator”, as described in claim, one can be made in several different ways using smaller buzzers and power source as well as positioning on the nail gun, depending on the nail feed apparatus, the nail gun reload indicator can be mounted externally or incorporated into the manufacturing of the gun, relying on the individual engineering for suitable placement.

4. The “nail gun reload indicator”, as described in claim three, can be activated by laser switch, which is mounted on top of the magazine of a nail gun, in such a way as a point down on to the fastener head of the nail gun. As the last nail passes the point of light, the laser shines on a switch, mounted at the location below, and in line with a laser, activating the reload indicator. The laser should be mounted in such a way as to be adjustable forward and backward at the discretion of the user.

5. The “nail gun reload indicator”, as described in claim three, may also be activated as a laser shines across the fastener supply with a switch opposite of it. The laser mounted in such a way as to be adjustable forward and backward and this application. The laser would have to shine on the switch continuously for a predetermined amount of time, due to the spacing of the nails in a clip.

6. The “nail gun reload indicator”, as described in claim three, may be activated by having a lever switch, mounted to the side of the magazine with the lever and contact with a clip of fasteners, that's being held in the off position. As the fasteners are expended, they move beyond the lever switch, releasing an alarm. It should be noted that this application may not be suitable for all brands of nail gun and trim guns. However, modifications can be made to the magazine of any magazine to accommodate this type of switch.

7. The “nail gun reload indicator”, as described in claim three, may use a device in the form of a magnetic switch, with another magnet mounted to the push handle. As nails are expended and push animals forward, the magnets are aligned, and the reload indicator is activated. The magnet mounted to the magazine should be adjustable forward and backward.

8. The“nail gun reload indicator”, as described in claim three, may also be activated by a proximity switch. This switch can be mounted on the pusher handle in such a way as to determine the proximity of the poster handle and relationship to a predetermined point on the magazine. As the nails, near depletion, they proximity switch, moves forward with the pusher handle, activating the alarm at a predetermined point.

9. The “nail gun reload indicator”, as described in claims three, four, five, six, seven and eight, our only examples of getting the same said result, that is alarming the user of a nail gun of the need to replenish the nails in a nail gun. Anyway of achieving this goal is covered in the side invention, “nail gun reload indicator”.

10. The audio aspect of the reload indicator is to provide a user with an audio alert as to the status of the nail gun supply. The sound emitted should be loud enough to be heard under normal construction noises, such as compressors, saws, etc.

11. The audio component, as described in claim 1, can be an electronic tone or buzzer that one sounded emits a continuous alarm.

12. The audio component, as described in claim 10, that can produce an intermittent tone or buzz.

13. The audio component, as described in claim 10, can alarm, intermittently as nails, near depletion, the intermission between sounds lesson until it's continuous when the nails are completely depleted.

14. Dividual aspects of the “nail gun reload indicator” is to provide a user with a visual alert as to the status of the nail supply.

15. The visual component, as described in claim 14, can be a light emitting diode. The light emitting diode should be bright enough to be easily noticed by the user. The light emitting diode should be located in obvious place on the nail gun, so the user can see the light being emitted. It is also important for the light emitting diode should be protected from hazardous conditions.

16. The visual component, as described in claim 14, emits, a red or orange, but is not limited to these colors.

17. The visual component, as described in claim 14, it's a continuous light, or may blink, but is not limited to this.

18. The visual component, as described in claim 14, Mae blink with decreased intermissions until it remains continuous at the depletion of the nail supply,

19. The “nail gun reload indicator”, as described in claim one, can be altered to specifications of the user or manufacture. The “nail gun reload indicator” is mounted to the outside of the nail gun, or can't be incorporated to the inside of the nail gun.

20. The “nail gun reload indicator”, as described in claim 19, can be originally mounted as reasonably as possible. At the same time, certain components must remain adjustable and accessible.

21. The “nail gun reload indicator”, as described in claim one, is activated by triggering mechanism. Regardless of the triggering mechanism, the concept of unloading the user of depletion in nails remains the same.

22. Let it be noted, did any change in the triggering device apply to the same pattern of the “nail gun reload indicator”, does not change the end result of the purpose of the device. Therefore, alternate sources could be used to achieve the same and result. They said, result, being, an alarm alerting the user, of a nail supply, and a nail gun nearing depletion or completely depleted of nails.
